(19) United States
(12) Patent Application Publication
(10) Pub. No.: US 2005/0286950 A1
(43) Pub. Date: Dec. 29, 2005

(54) Print control device having a printer driver and a method of controlling print options

(76) Inventor: Young-gu Kim, Suwon-si (KR)

Correspondence Address: STANZIONE & KIM, LLP, 919 18TH STREET, N.W., SUITE 440, WASHINGTON, DC, 20006, US

(21) Appl. No.: 11/157,941

(22) Filed: Jun. 22, 2005

(30) Foreign Application Priority Data
Jun. 23, 2004 (KR) 2004-47152

(51) Int. Cl. B41J 29/38

(52) U.S. Cl. 400/76

(57) ABSTRACT

A print control device having a printer driver and a method of controlling print options. The printer driver creates and outputs a changed print option item menu to manage print option items having changed print option values among a plurality of print option items. Accordingly, previously set print option information can easily be confirmed using the changed item menu, and a user is not required to remember the previously set print option information.

### CROSS-REFERENCE TO RELATED APPLICATIONS

This application claims the benefit under 35 U.S.C. § 119 from Korean Patent Application No. 200447152 filed on Jun. 23, 2004, the entire content of which is incorporated herein by reference.

### BACKGROUND OF THE INVENTION

1. Field of the Invention

The present general inventive concept generally relates to a print control device, and more particularly, to a print control device having a driver program to set one or more print options applied to a document for printing and a method of controlling the one or more print options using the same.

2. Description of the Related Art

Generally, in order to print a document prepared by an application program on a computer using a printer, a printer driver that is typically provided by a printer manufacturer to control a print function of the printer is installed on the computer.

The printer driver provides a user interface (UI) that can set print options to be applied to the document for printing. The user may set the print options (e.g., print range, a kind of print paper, etc.) to be applied to the document for printing using the UI provided by the printer driver. Typically, if the print options are changed by the user, the document is printed according to the changed print options. On the other hand, if the print options are not changed by the user, the document is printed with default values set for the print options when the printer driver is installed.

Although the user changes the print options, previously set print options (including the changed print options) are maintained until the application program executed by the computer is terminated. Accordingly, if the user does not terminate the application program and intends to perform a print job according to print options that are the same as the previously set print options, it is not necessary for the user to re-set the print options.

However, in the UI provided by the printer driver, both the previously changed print options and the print options that maintain default values are displayed. In other words, the print options having the default values and the print options having the changed values are displayed together. Accordingly, it is difficult for a user, who does not remember all the previously changed print options to determine which ones of the print options are previously changed by the user. Thus, in order for the user to determine whether the print options are changed from the default values, the user should move to a respective tap for displaying a print option list, should manually keep track of the previously changed print options, or should re-set the print options through trial and error to match the previously changed print options. This causes the user an inconvenience.

### SUMMARY OF THE INVENTION

The present general inventive concept provides a print control device having a driver program that provides a user interface (UI) capable of managing print option items having changed print option values among a plurality of print option items, and a method of controlling print options.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a print control device comprising a printer driver to set one or more print options having print option items to be applied to a document for printing and to create and output a changed print option item menu to manage the print option items having changed print option values from among a plurality of print option items.

The print control device may further comprise a display unit to display the changed print option item menu created by the printer driver.

The printer driver may comprise a menu creating unit to create the changed print option item menu, and a driver control unit to control the menu creating unit to create the changed print option item menu to include at least one print option item having a corresponding at least one print option value that is changed from a default value among the print option items having the changed print option values.

The changed print option item menu may include the at least one print option item, the corresponding at least one print option value set for the respective at least one print option item, and at least one default value icon to change the corresponding at least one print option value set for the respective at least one print option item back to the default value.

The driver control unit may control the menu creating unit to create a scroll bar on the changed print option item menu when more than a predetermined number of print option items are displayed on the changed print option item menu.

When the print option value of any one of the at least one print option item displayed on the changed print option item menu is changed to a specified print option value, the driver control unit may update the respective print option value to the specified print option value.

If the specified print option value is the default value, the drive control unit removes the print option item having the print option value that is changed to the specified print option value from the changed print option item menu.

The foregoing and/or other aspects and advantages of the present general inventive concept may also be achieved by providing a method of controlling print options to be applied to a document for printing, the method comprising determining whether at least one print option item of a plurality of print option items has a corresponding at least one print option value that is changed, creating a changed print option item menu including the at least one print item when the at least one print option has the corresponding at least one changed print option value, and displaying the created changed print option item menu.

The determining of whether the at least one print option of the plurality of the print option items has the corresponding at least one changed print option value comprises determining whether the at least one print option item has a corresponding at least one print option value that is changed from a default value.

The creating of the changed print option item menu may comprise creating the changed print option item menu to include the at least one print option item having the corresponding at least one print option value that is changed from the default value.

The changed print option item menu may comprise the at least one print option item having the corresponding at least one print option value that is changed from the default value, the corresponding at least one print option value set for the respective at least one print option item, and at least one default value icon to change the corresponding at least one print option value set for the respective at least one print option item to the default value.

The creating of the changed print option item menu may comprise creating a scroll bar on the changed print option item menu when more than a predetermined number of print option items are displayed on the changed print option item menu.

The method may further comprise updating a print option value to a changed print option value when any of the at least one print option value of the corresponding at least one print option item that is displayed on the changed print option item menu is changed.

The method may further comprise removing a print option item having a print option value that is changed to the default value from the changed print option item menu.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a print processing system having a print control device according to an embodiment of the present general inventive concept;

FIG. 2 is a view illustrating an example of a print setting window that corresponds to a print command;

FIGS. 3A to 3D are views illustrating examples of print option setting screens according to embodiments of the present general inventive concept;

FIG. 4 is a flowchart illustrating a method of creating a changed item menu according to an embodiment of the present general inventive concept; and

FIG. 5 is a flowchart illustrating a method of managing print option items having changed print option values according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

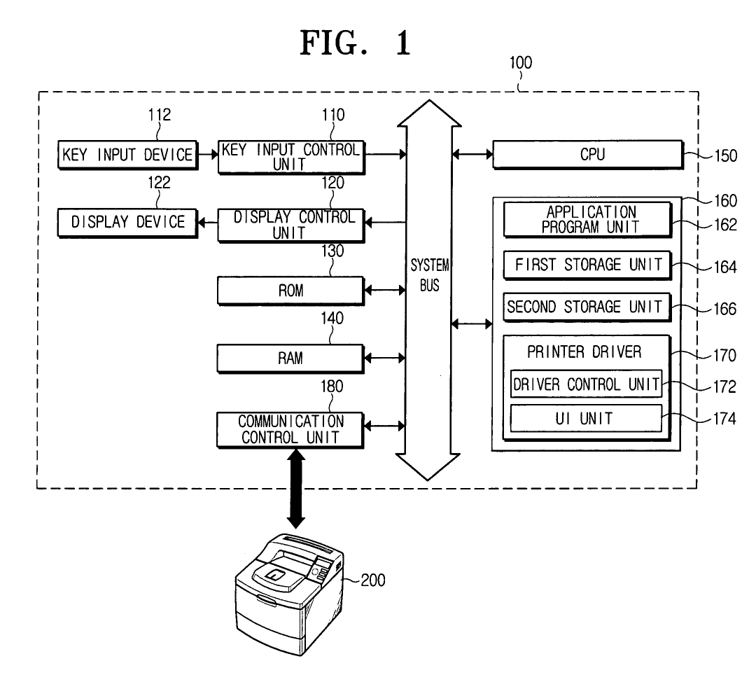

FIG. 1 is a block diagram illustrating a print processing system having a print control device according to an embodiment of the present general inventive concept.

Referring to FIG. 1, the print processing system according to an embodiment of the present general inventive concept comprises a host computer 100 and a printer 200. The host computer 100 and the printer 200 can communicate with each other through a general connection means, such as a USB port, a LAN (Local Area Network), or the Internet.

The host computer 100 may include a key input control unit 110, a display control unit 120, a read-only memory (ROM) 130, a random access memory (RAM) 140, a central processing unit (CPU) 150, a hard disc drive (HDD) 160, and a communication control unit 180. In FIG. 1, a system bus may be used as a data transmission path among the key input control unit 110, the display control unit 120, the ROM 130, the RAM 140, the CPU 150, the HDD 160, and the communication control unit 180.

The key input control unit 110 is connected to a key input device 112 and provides a key input signal input from the key input device 112 to the CPU 150. The key input device 112 may be a user interface including a plurality of function keys that can set and/or select functions supported by the host computer 100. For example, the key input device 112 may include a keyboard, a mouse, a keypad, or a touch screen.

The display control unit 120 is connected to a display device 122, and provides display information from the CPU 150 to the display device 122. The display device 122 displays the display information received from the display control unit 120. The display device 122 may be, for example, a monitor having a cathode ray tube (CRT) or a liquid crystal display (LCD).

The ROM 130 stores control programs to implement functions of the host computer 100. Specifically, the ROM 130 stores an operating system (OS), which is a control program of the CPU 150.

The RAM 140 temporarily stores data produced by a program executed by the CPU 150. The RAM 140 acts as a main memory of the CPU 150, and the program executed by the CPU 150 can be loaded from the ROM 130 or the HDD 160.

The CPU 150 controls overall operation of the host computer 100 by executing the control program stored in the ROM 130. The CPU 150 can further execute an application program related to preparation of a document for printing and/or a program related to a printer driver 170.

The HDD 160 comprises an application program unit 162, a first storage unit 164, a second storage unit 166, and the printer driver 170.

The application program unit 162 stores application programs used to prepare various types of documents. A user can prepare the document for printing using one or more application programs stored in the application program unit 162.

The first storage unit 164 stores information about a plurality of print option items corresponding to a print function of the printer 200 and print option values set for the respective print option items. The print option values of the respective print option items are default values until the user changes the corresponding print option values. Here, the default values refer to values that are set when the printer driver 170 is installed on the HDD 160.

The second storage unit 166 stores information about one or more print option items (from among the plurality of the print option items) having changed print option values and the changed print option values. More specifically, the second storage unit 166 stores information about the print option items having the print option values that are changed from the default values.

The printer driver 170 provides a print option setting screen to set the print options (e.g., a paper size, a paper kind, a feeding direction, and a number of papers to be printed) to be applied to the document prepared by the one or more application programs of the application program unit 162. The print options may include the print option items and the print option values corresponding to the print option items. Additionally, the printer driver 170 creates and displays a changed print option item menu (hereinafter, referred to as a “changed item menu”) that includes the print option items having the changed print option values selected from among the plurality of print option items provided by the print option setting screen. Thus, the changed item menu is included in the print option setting screen. Additionally, the print option setting screen and the changed item menu are user interfaces (UIs) provided by the printer driver 170.

More specifically, as illustrated in FIG. 1, the printer driver 170 may include a driver control unit 172 and a UI unit 174.

The driver control unit 172 controls the UI unit 174 to create the print option setting screen that corresponds to a print command received from the application program unit 162. Additionally, the driver control unit 172 controls the UI unit 174 to create the changed item menu using the print option items having the changed print option values. In some embodiments of the present general inventive concept, the changed item menu only includes the print option items that have been changed from the default values. For this, the driver control unit 172 determines whether there are print option items that have changed print option values displayed among the plurality of print option items on the print option setting screen. The driver control unit 172 also determines whether the print option items that have the changed print option values have values that are different from the default values.

The UI unit 174 creates the print option setting screen and the changed item menu according to control of the driver control unit 172. A menu screen created by the UI unit 174 is displayed on the display device 122 by the display control unit 120. The changed item menu may include the print option items having the print option values that have been changed from the default values from among the print option items having the changed print option values.

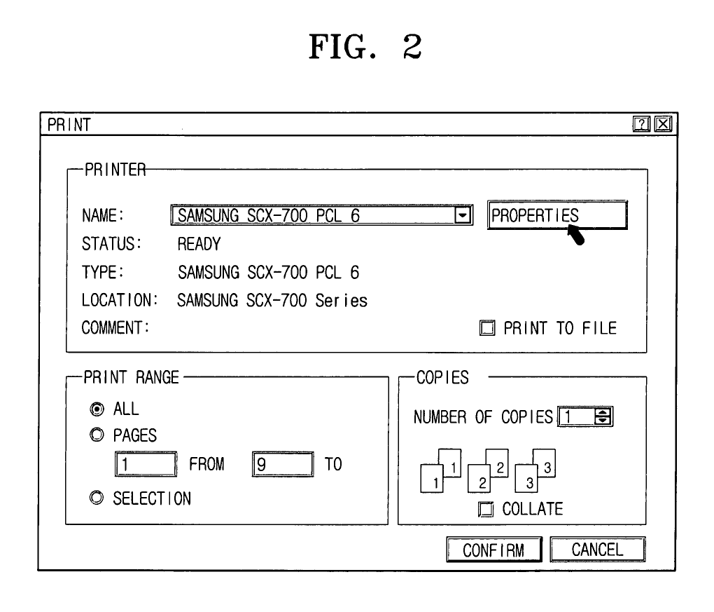

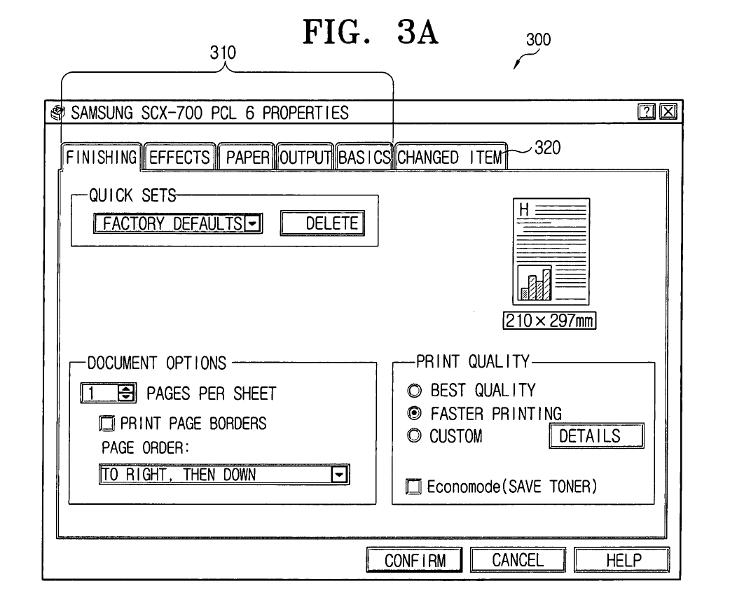

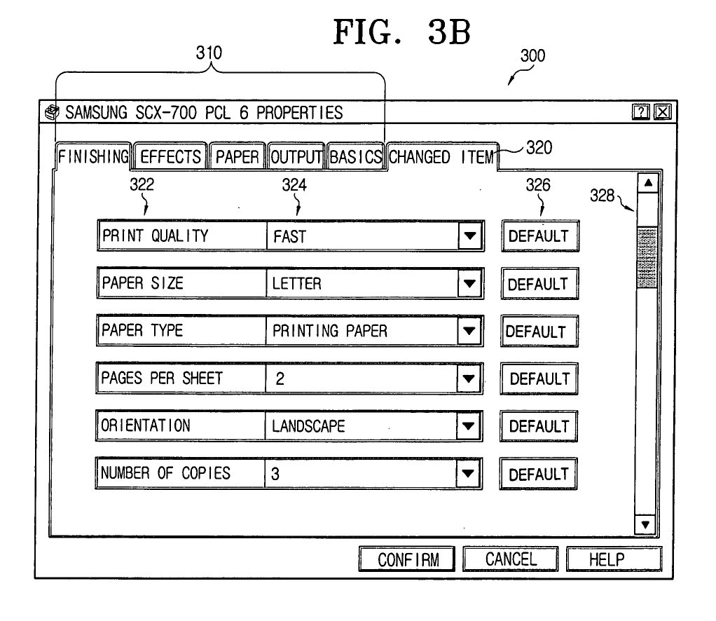

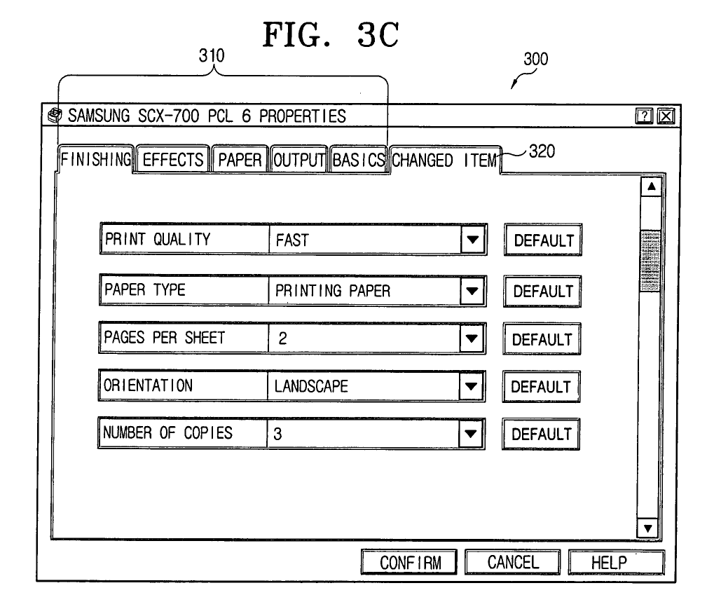

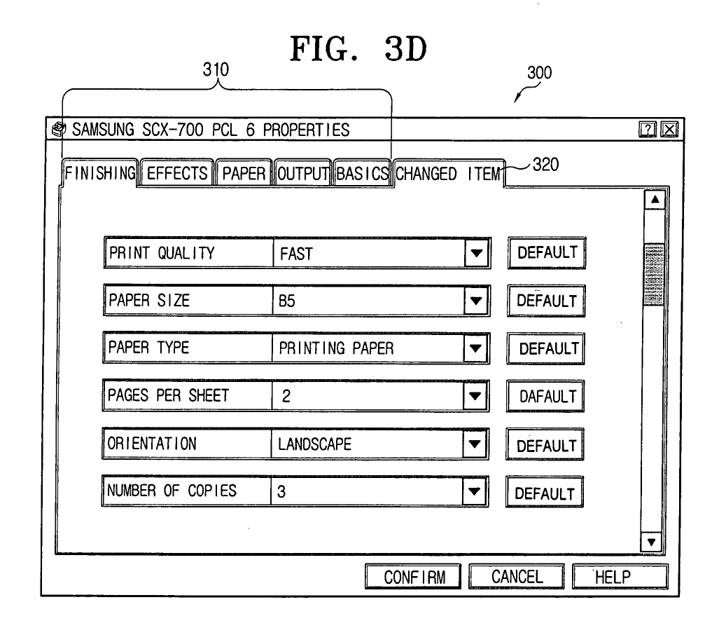

A method of creating the changed item screen menu including the print option items having the changed print option values will now be described with reference to FIG. 1. FIG. 2 is a view illustrating an example of a print setting window that corresponds to a print command. FIGS. 3A to 3D are views illustrating examples of print option setting screens provided by the printer driver 110 illustrated in FIG. 1.

When a print command is received to print a document prepared by the application program unit 162, the display device 122 displays the print setting window as illustrated in FIG. 2. If a properties button is selected in the print setting window, the display device 122 displays a print option setting screen 300, as illustrated in FIG. 3A.

FIG. 3A is a view illustrating an example of the print option setting screen 300 created by the UI unit 174. As illustrated in FIG. 3A, the print option setting screen 300 includes an option item menu 310 to provide a plurality of print option items to enable setting of the print option values to be applied to the document for printing. The print option setting screen 300 further includes a changed item menu 320 to manage the print option items having changed print option values.

If the print option value of a specified print option item displayed in the option item menu 310 is changed, the driver control unit 172 determines whether the changed print option value of the specified print option item is the default value. If the changed print option value of the specified print option item is not the default value, the driver control unit 172 stores the specified print option item and the corresponding changed print option value that is different from the default value in the second storage unit 166. As described above, the driver control unit 172 according to an embodiment of the present general inventive concept can store both the specified print option item having the changed print option value and the changed print option value itself in the second storage unit 166. Thus, whenever a print option value of a print option item displayed in the option item menu 310 is changed to a value that is different from the default value, the changed print option value and the corresponding print option item are stored in the second storage unit 166. The driver control unit 172 then controls the UI unit 174 to provide the changed item menu 320 including the print option items stored in the second storage unit 166.

If the changed item menu 320 is selected on the print option setting screen 300 illustrated in FIG. 3A, information about the print option items having the print option values that are changed from the default values is displayed by the changed item menu 320 as illustrated in FIG. 3B. The changed item menu 320, as illustrated in FIG. 3B, comprises print option items 322 having changed print option values, print option values 324 set for the respective print option items 322, default value icons 326 that can be selected to change the print option values 324 set for the respective print option items 322 back to the default values, and a scroll bar 328. The scroll bar 328 may be created when the changed print option items 322 are too many to be displayed simultaneously in a viewable part of the changed item menu 320. Additionally, when a default value icon 326 is selected to change the corresponding print option item 322 having the print option value 324 back to the default value, the corresponding print option item 322 is then removed from the changed item menu 320 and the second storage unit 166.

Referring back to FIG. 3A, when the print option value of any print option item (e.g., paper size item) among the print option items displayed in the changed item menu 320 is re-changed, the driver control unit 172 determines whether the print option value that is re-changed is the default value (i.e., changed back to the default value). If the re-changed print option value is the default value (e.g., A4 size), the driver control unit 172 removes the print option item that has been re-changed back to the default value from the changed item menu 320. For example, if the paper size item of FIG. 3B is changed from “Letter” back to “A4” (the default value), or if the default value icon 326 corresponding to the paper size item is selected, the driver control unit 172 removes the paper size item from the changed item menu 320, as illustrated in FIG. 3C. In this case, the print option item, which has the corresponding print option value changed back to the default value, is also removed from a print option item list stored in the second storage unit 166. Additionally, once the driver control unit 172 removes the print option item having the corresponding print option value changed back to the default value from the changed item menu 320, the driver control unit 172 then changes the print option value of the paper size item displayed in the option item menu 310 back to the default value.

When the changed print option value is (e.g., B5 size) different from the default value, the driver control unit 172 changes both the print option value of the print item option (e.g., the paper size item) displayed in the changed item menu 320 and the print option value of the print option item (e.g., the paper size item) displayed in the option item menu 310 to the changed print option value (e.g., B5 size). Accordingly, as illustrated in FIG. 3D, the print option value of the paper size item in the changed item menu 320 is changed from “Letter” to “B5.”

Referring back to FIG. 1, the communication control unit 180 is connected to the printer 200 through a communication network, and controls a bi-directional communication interface with the printer 200. The communication control unit 180 transmits print data provided by the printer driver 170 to the printer 200 according to control of the CPU 150.

The printer 200 then prints the print data provided by the printer driver 170 of the host computer 100 according to set print options.

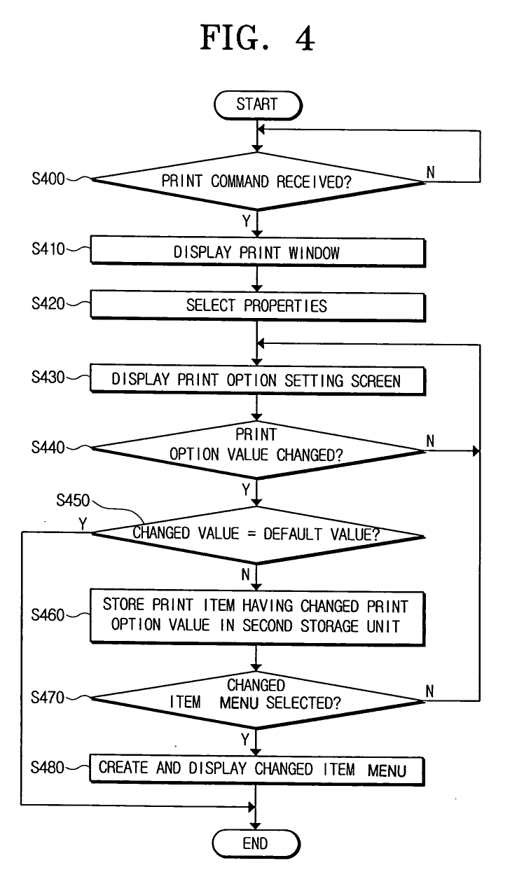

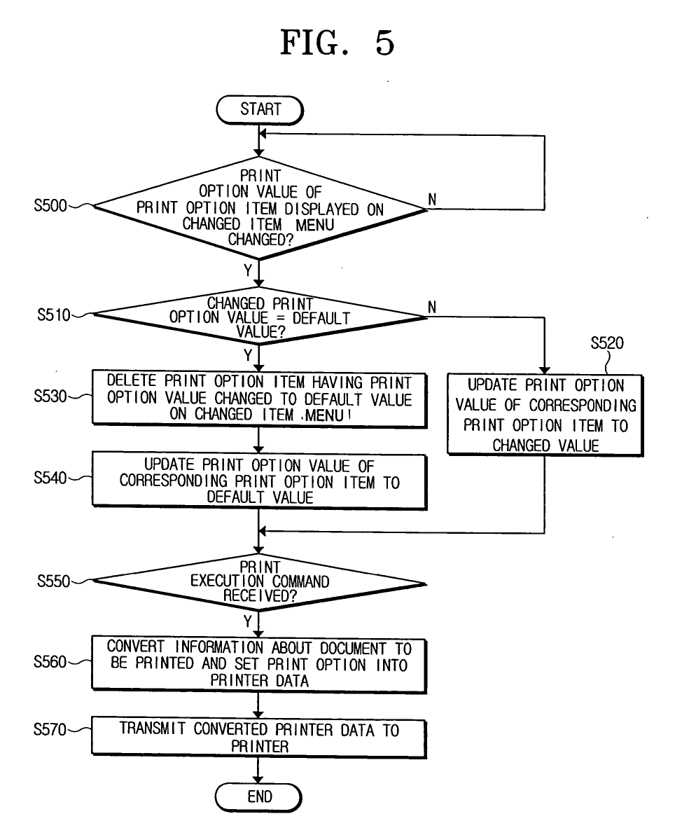

Hereinafter, a method of creating the changed item menu and a method of managing the print options using the changed item menu will be described with reference to FIGS. 4 and 5.

FIG. 4 is a flowchart illustrating the method of creating the changed item menu according to an embodiment of the present general inventive concept. In some embodiments, the method may be performed by the printer driver 170 illustrated in FIG. 1.

Referring to FIGS. 1 to 4, when a print command to print a document prepared by the application program unit 162 is received (operation S400), the application program unit 162 operates to display the print setting window as illustrated in FIG. 2 using the display device 122 (operation S410).

When a properties button is selected in the print setting window (operation S420), the driver control unit 172 operates to display the print option setting screen 300 created by the UI unit 174 using the display device 122 (operation S430). Accordingly, the print option setting screen 300, as illustrated in FIG. 3A, is displayed by the display device 122. As illustrated in FIG. 3A, the print option setting screen 300 includes the option item menu 310 to provide a plurality of print option items and the changed item menu 320 to manage the print option items having corresponding print option values that are changed.

If the print option value of any one of the plurality of print option items displayed on the option item menu 310 is changed by the user (operation S440), the driver control unit 172 determines whether the changed print option value is the default value (operation S450). Operation S450 enables the changed item menu 320 to manage only the print option items having corresponding print option values that are changed from the default values selected from among the plurality of print option items displayed on the option item menu 310.

When the changed print option value is determined not to be the default value at operation S450, the driver control unit 172 stores information about the print items having corresponding print option values that are changed in the second storage unit 166 in order to add the print option items having the changed option values to the changed item menu 320 (operation S460).

Then, when the changed item menu 320 provided on the print option setting screen 300 is selected by the user (operation S470), the driver control unit 172 controls the UI unit 174 to create the changed item menu 320 using the print option items stored in the second storage unit 166. The UI unit 174 creates the changed item menu 320 based on print option item information stored in the second storage unit 166 and outputs the created changed item menu 320 to the display device 122 according to control of the driver control unit 172 (operation S480). Accordingly, the changed item menu 320, as illustrated in FIG. 3B, is displayed on the display device 122.

As illustrated in FIG. 3B, by showing the print option items having the print option values changed from the default values in the changed item menu 320, the user is not required to individually search the option item menu 310 in order to confirm previously changed print option items. Additionally, since the second storage unit 166 stores the changed print option items even after the application program unit 162 terminates the one or more application programs, recently changed print option items can be saved.

FIG. 5 is a flowchart illustrating a method of managing print option items having changed print option values according to an embodiment of the present general inventive concept. The method of FIG. 5 is described below with reference to FIGS. 1 to 5.

When the print option value of any one (e.g., paper size item) of the plurality of print option items displayed on the changed item menu 320 is re-changed as illustrated in FIG. 3B (operation S500), the driver control unit 172 determines whether the re-changed print option value is the default value (operation S510). That is, the driver control unit 172 determines whether a default value icon corresponding to the paper size item is selected.

When the re-changed print option value is determined not to be the default value (e.g., A4 size) at operation S510, the driver control unit 172 updates the print option value of the re-changed print option item (e.g., the paper size item) displayed on the changed item menu 320 to the changed print option value (e.g., B5). Accordingly, as illustrated in FIG. 3D, the print option value of the re-changed print option item (e.g., the paper size item) displayed on the changed item menu 320 is changed, for example, from “Letter” to “B5.”

When the re-changed print option value is determined to be the default value (e.g., A4 size) at operation S510, the driver control unit 172 removes the print option item having the corresponding print option value that is changed back to the default value (e.g., the paper size item) from the changed item menu 320 (operation S530). That is, the driver control unit 172 removes the print option item having the print option value that is changed back to the default value (e.g., paper size item) from among the print option items stored in the second storage unit 166.

Once the print option item having the corresponding value changed back to the default value is removed from the changed item menu 320 at operation S530, the driver control unit 172 updates the print option value of the print option item having the changed value (e.g., paper size item) displayed on the option item menu 310 back to the default value (e.g., A4 size).

Then, when a print execution command is received (at operation S550), the driver control unit 172 converts information about the document to be printed and set print options to be applied to the document into print data that can be recognized by the printer 200 (operation S560). The printer data converted by the driver control unit 172 is then transmitted to the printer 200 by the communication control unit 180 (operation S570).

For example, the printer 200 converts the printer data transmitted from the host computer 100 into bit-map data that can be recognized by a print engine unit (not illustrated), and prints the converted bit-map data according to the set print options. Although FIGS. 2 and 3A through 3D have particular screen and menu arrangements, it should be understood by one of ordinary skill in the art that the arrangements of the figures are merely exemplary and that other arrangements may alternatively be used without departing from the scope of the present general inventive concept.

The present general inventive concept may be embodied as executable code in computer readable media including storage media such as magnetic storage media (ROMs, RAMs, floppy disks, magnetic tapes, etc.), optically readable media (CD-ROMs, DVDs, etc.), and carrier waves (transmission over the Internet). For example, the computer readable media may contain a printer driver program.

As described above, according to a print control device having a printer driver and a print option control method according to an embodiment of the present general inventive concept, print option items having corresponding print option values that are changed by a user can be managed by a changed item menu. Accordingly, previously set print option information can easily be confirmed using the changed item menu. Thus, the user is not required to remember the previously set print option information.

Additionally, if a print option value of a print option item that is on the changed item menu is changed back to a default value, the corresponding print option item can be removed from the changed item menu. Accordingly, an update of the changed print option menu becomes possible.

Consequently, when performing a print job using previously set print option information, additional setting of a new print option and a change of the previously set print option can easily be performed, thereby providing convenience to a user.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A print control device, comprising:
a printer driver to set one or more print options having print option items to be applied to a document for printing and to create and output a changed print option item menu used to manage the print option items having changed print option values.

2. The print control device as claimed in claim 1, further comprising:
a display unit to display the changed print option item menu created by the printer driver.

3. The print control device as claimed in claim 1, wherein the printer driver comprises:
a menu creating unit to create the changed print option item menu; and
a driver control unit to control the menu creating unit to create the changed print option item menu to include at least one of the print option items having a corresponding at least one print option value changed from a default value among the print option items having the changed print option values.

4. The print control device as claimed in claim 3, wherein the changed print option item menu includes:
the at least one print option item,
the corresponding at least one print option value set for the respective at least one print option item, and
at least one default value icon to change the corresponding at least one print option value set for the respective at least one print option item back to the default value.

5. The print control device as claimed in claim 4, wherein the driver control unit controls the menu creating unit to create a scroll bar on the changed print option item menu when more than a predetermined number of print option items are displayed on the changed print option item menu.

6. The print control device as claimed in claim 4, wherein when a print option value of any one of the at least one print option item displayed on the changed print option item menu is changed to a specified print option value, the driver control unit updates the respective print option value to the specified print option value.

7. The print control device as claimed in claim 6, wherein if the specified print option value is the default value, the drive control unit removes the print option item having the respective print option value that is changed to the specified print option value from the changed print option item menu.

8. A print control device, comprising:
a printer driver to set one or more print options including a first print option item having a default value and a second print option item having a changed value different from the default value, and to create a changed print option item menu corresponding to at least one of the second print option item and the changed value.

9. The print control device as claimed in claim 8, wherein the printer driver creates a print option setting screen having the one or more print options, and the changed print option item menu is included in the print option setting screen.

10. The print control device as claimed in claim 8, wherein the changed print option item menu does not include the first print option item.

11. The print control device as claimed in claim 8, wherein the changed print option item menu comprises a default value icon to change the changed value to the default value.

12. The print control device as claimed in claim 8, wherein the changed print option item menu comprises a selection button to change the changed value to a second changed value.

13. A print option managing device, comprising:
a user interface unit to display a print option setting screen having a plurality of print options; and
a printer driver to control the user interface unit to display one or more first print options that are changed, and one or more second print options that are not changed such that the one or more first print options are distinguished from the one or more second print options.

14. A print option managing device, comprising:
a print option setting screen to set a plurality of print options;
a storage device to store one or more print options having changed values and the corresponding changed values; and
a changed item menu creating unit to receive a print command and to identify the one or more changed print options among the plurality of print options in the print option setting screen by accessing the storage device to determine the one or more changed print options.

15. A user interface usable with a printing system, comprising:
a print option setting screen having a plurality of print options, the print option setting screen comprising:
a first portion to display all of the plurality of print options; and
a second portion to display one or more of the plurality of print options that have non-default print option values.

16. A method of controlling print options to be applied to a document for printing, the method comprising:
determining whether at least one print option item of a plurality of print option items has a corresponding at least one print option value that is changed;
creating a changed print option item menu including the at least one print item when the at least one print option item has the corresponding at least one changed print option value; and
displaying the created changed print option item menu.

17. The method as claimed in claim 16, wherein the determining of whether the at least one print option of the plurality of print option items has the corresponding at least one changed print option value comprises determining whether the at least one print option item has a corresponding at least one print option value that is changed from a default value.

18. The method as claimed in claim 17, wherein the creating of the changed print option item menu comprises creating the changed print option item menu to include the at least one print option item having the corresponding at least one print option value that is changed from the default value.

19. The method as claimed in claim 18, wherein the changed print option item menu includes the at least one print option item having the corresponding at least one print option value that is changed from the default value, the corresponding at least one print option value set for the respective at least one print option item, and at least one default value icon to change the corresponding at least one print option value set for the respective at least one print option item to the default value.

20. The method as claimed in claim 19, wherein the creating of the changed print option item menu comprises creating a scroll bar on the changed print option item menu if more than a predetermined number of print option items are displayed on the changed print option item menu.

21. The method as claimed in claim 19, further comprising:
updating a print option value corresponding to a changed print option value when any of the at least one print option value of the at least one corresponding print option item displayed on the changed print option item menu is changed.

22. The method as claimed in claim 21, further comprising:
removing a print option item having a print option value that is changed to the default value from the changed print option item menu.

23. A method of a user interface usable with a print system, the method comprising:
displaying a print option setting screen having a plurality of print options, the displaying of the print option setting screen comprising:
displaying a first portion including all of the plurality of print options; and
displaying a second portion including one or more of the plurality of print options that have non-default print option values.

24. A method of managing print options, the method comprising:
displaying a print option setting screen having a plurality of print options; and
controlling the print option setting screen to distinguish between one or more first print options that are changed and one or more second print options that are not changed.

25. A method of managing print options, the method comprising:
displaying a window having a plurality of print options;
identifying at least one of the plurality of print options that has been changed;
enabling a user to change the plurality of print options; and
updating the identified at least one of the plurality of print options that has been changed when any of the plurality of print options are changed.

26. A computer readable medium containing executable code to create a user interface, the medium comprising:
an executable code to display a print option setting screen having a plurality of print options, the executable code comprising:
a first executable code to display a first portion including all of the plurality of print options; and
a second executable code to display second portion including one or more of the plurality of print options that have non-default print option values.

27. A computer readable medium containing executable code to control print options to be applied to a document for printing, the medium comprising:
a first executable code to determine whether at least one print option item of a plurality of print option items has a corresponding at least one changed print option value;
a second executable code to create a changed print option item menu including the at least one print item when the at least one print option item has the corresponding at least one changed print option value; and
a third executable code to display the created changed print option item menu.
